(19) United States
(12) Patent Application Publication
(10) Pub. No.: US 2024/0257185 A1
(43) Pub. Date: Aug. 1, 2024

(54) SYSTEM AND METHOD FOR ESTIMATING ADVERTISEMENT IMPRESSIONS NEEDED TO DETECT SALES LIFT

(71) Applicant: Walmart Apollo, LLC, Bentonville, AR (US)

(72) Inventors: Hangjian Li, Issaquah, WA (US); Yuan Feng, Los Altos, CA (US); Dong Xu, Sunnyvale, CA (US)

(21) Appl. No.: 18/424,020

(22) Filed: Jan. 26, 2024

Related U.S. Application Data
(60) Provisional application No. 63/442,270, filed on Jan. 31, 2023.

(51) Int. Cl. G06Q 30/0273; G06Q 30/0202; G06Q 30/0242

(52) U.S. Cl. CPC G06Q 30/0273; G06Q 30/0202; G06Q 30/0246

(57) ABSTRACT

Systems and methods for estimating advertisement impressions needed for detecting sales lift are disclosed. In some embodiments, based on an impression estimation request received from a computing device, a disclosed system determines an item set including items proposed to be advertised with an advertising campaign, and a time period proposed for the advertising campaign. Based on at least one model and historical transaction data associated with the item set, control sales data in the time period is computed for the item set without the advertising campaign. Based on a trained model and additional data associated with the item set, the system computes a number of impressions needed to detect a target sales lift compared to the control sales data in the time period for the item set with the advertising campaign. Based on the number of impressions, the system generates and transmits estimated impression data to the computing device.

### CROSS-REFERENCE TO RELATED APPLICATION

This application claims benefit to U.S. Provisional Application Ser. No. 63/442,270, entitled “System and Method for Estimating Advertisement Impressions Needed to Detect Sales Lift,” filed on Jan. 31, 2023, the disclosure of which is incorporated herein by reference in its entirety.

### TECHNICAL FIELD

This application relates generally to advertising and, more particularly, to systems and methods for estimating advertisement impressions needed to detect sales lift.

### BACKGROUND

An advertisement may be a presentation or communication to promote an item, such as a product or service, for purchase. At least some advertisements are digital advertisements, which include a digital representation of the presentation or communication, such as one displayed on a website. A sponsor of an advertisement, such as a business, may seek to sell the item in the advertisement. The sponsor may advertise the item in the advertisement to notify potential buyers of the sale of the item, thereby increasing the chances of selling the item. For example, the sponsor may advertise the item on a website, such as a retailer's website. In at least some examples, the advertisement may be part of an advertising campaign that identifies one or more products to promote on the website.

At least some sponsors pay a fee to have an item advertised. For example, a sponsor may pay a fee to a retailer to advertise the sponsor's item on the retailer's website, or through an advertising campaign. The amount of the fee may depend on the number of impressions the item advertisement receives. An impression of an advertisement is when a customer sees the advertisement. In practice, an impression occurs any time a customer opens an app or website where the advertisement is visible. While the sponsor intends to lift the sales of the item by paying the advertisement fee based on impressions, the sponsor wants to know how many impressions are needed to detect a target sales lift before the advertising campaign starts and before paying the fee. But there is no existing method for a sponsor or an advertiser to determine the advertisement impressions needed to detect the target sales lift before the advertising campaign starts, except based on subjective experience and random guess.

### SUMMARY

The embodiments described herein are directed to systems and methods for estimating advertisement impressions needed for detecting sales lift.

In various embodiments, a system including a non-transitory memory configured to store instructions thereon and at least one processor is disclosed. The at least one processor is operatively coupled to the non-transitory memory and configured to read the instructions to: receive, from a computing device, an impression estimation request; determine, based on the impression estimation request, an item set including items proposed to be advertised with an advertising campaign, and a time period proposed for the advertising campaign; compute, based on at least one model and historical transaction data associated with the item set, control sales data in the time period for the item set without the advertising campaign; compute, based on a trained model and additional data associated with the item set, a number of impressions needed to detect a target sales lift compared to the control sales data in the time period for the item set with the advertising campaign; generate estimated impression data based on the number of impressions; and transmit, in response to the impression estimation request, the estimated impression data to the computing device.

In various embodiments, a computer-implemented method is disclosed. The computer-implemented method includes: receiving, from a computing device, an impression estimation request; determining, based on the impression estimation request, an item set including items proposed to be advertised with an advertising campaign, and a time period proposed for the advertising campaign; computing, based on at least one model and historical transaction data associated with the item set, control sales data in the time period for the item set without the advertising campaign; computing, based on a trained model and additional data associated with the item set, a number of impressions needed to detect a target sales lift compared to the control sales data in the time period for the item set with the advertising campaign; generating estimated impression data based on the number of impressions; and transmitting, in response to the impression estimation request, the estimated impression data to the computing device.

In various embodiments, a non-transitory computer readable medium having instructions stored thereon is disclosed. The instructions, when executed by at least one processor, cause at least one device to perform operations including: receiving, from a computing device, an impression estimation request; determining, based on the impression estimation request, an item set including items proposed to be advertised with an advertising campaign, and a time period proposed for the advertising campaign; computing, based on at least one model and historical transaction data associated with the item set, control sales data in the time period for the item set without the advertising campaign; computing, based on a trained model and additional data associated with the item set, a number of impressions needed to detect a target sales lift compared to the control sales data in the time period for the item set with the advertising campaign; generating estimated impression data based on the number of impressions; and transmitting, in response to the impression estimation request, the estimated impression data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for estimating advertisement impressions needed for detecting sales lift, in accordance with some embodiments of the present teaching.

FIG. 2 is a block diagram of an impression estimation computing device, in accordance with some embodiments of the present teaching.

FIG. 3 is a block diagram illustrating various portions of a system for estimating advertisement impressions needed for detecting sales lift, in accordance with some embodiments of the present teaching.

FIG. 4 illustrates a process for providing sales lift report estimates to a user upon request, in accordance with some embodiments of the present teaching.

FIGS. 5-9 illustrate a user interface displaying webpages provided to a user for providing sales lift report estimates, in accordance with some embodiments of the present teaching.

FIG. 10 illustrates an exemplary method for computing estimated impression data to detect a target sales lift, in accordance with some embodiments of the present teaching.

FIG. 11 is a flowchart illustrating an exemplary method for estimating advertisement impressions needed for detecting sales lift, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Advertisement sponsors (or advertisers) often pay a fee for an advertising campaign according to desired impressions. The more impressions an advertiser books or buys for a campaign, the more customers will likely be impacted, and the more sales lift can be expected. But given a target sales lift, e.g. 10%, advertisers wants to understand if this 10% lift of the sales is indeed that statistically significant to them. As such, advertisers want to know how many impressions are needed to detect a target sales lift with a certain confidence level and strong statistical significance before the advertising campaign starts and before paying the fee. To address this concern, various embodiments of the present teaching provide a pre-campaign diagnostic tool to help the advertisers to assess if their budget for impressions are going to lead to detectable sales lift. Having this tool updated with the latest and stable methodology is very important to provide the advertisers (and associated sales teams) with guidance on campaign setup.

Before a campaign starts, the diagnostic tool can estimate the number of impressions required to detect a non-zero sales lift with sufficient statistical power and significance. In some embodiments, the diagnostic tool utilizes an impression estimator to estimate impressions needed to detect a target sales lift, based on user inputs such as item set, campaign time frame, channel, category, etc. A user of the tool in the present teaching may refer to an advertiser, an advertisement sponsor, or any campaign manager who helps to set up and/or maintain a campaign for advertisers. In various embodiments, the impression estimator can help to determine whether a campaign is a good candidate for sales lift, which is especially useful to meet or exceed goals for “performance-guaranteed” campaigns.

In various embodiments, the impression estimator is used to assess if a campaign has sufficient impressions to detect non-zero sales lift for an item set under consideration. An item set includes a set of items that can be impacted together by a same campaign. For example, the estimator may consider the campaign length (including the reporting period), as well as the conversion frequency of the item set, to assess the minimum number of impressions required to detect a sales lift above an established threshold (usually larger than zero), e.g. at a 95% confidence level with 80% statistical power, across onsite and offsite properties.

In some embodiments, the impression estimator is built based on a power analysis theory that is tailored towards different advertising campaign verticals. By taking into consideration the factors that are unique to advertisement business such as match rate, variance adjustment factor, and impression frequency, the estimator can make more robust estimates of the impressions required for different item categories. In some examples, the estimator uses the pre-campaign weekly item sales data to interpolate or extrapolate the in-campaign sales means and variances for the test and control groups, and estimate a lower bound and an upper bound for the required number of impressions.

Furthermore, in the following, various embodiments are described with respect to methods and systems for estimating advertisement impressions needed for detecting sales lift. In some embodiments, based on an impression estimation request received from a computing device, a disclosed system determines an item set including items proposed to be advertised with an advertising campaign, and a time period proposed for the advertising campaign. Based on at least one model and historical transaction data associated with the item set, control sales data in the time period is computed for the item set without the advertising campaign. Based on a trained model and additional data associated with the item set, the system computes a number of impressions needed to detect a target sales lift compared to the control sales data in the time period for the item set with the advertising campaign. Based on the number of impressions, the system generates and transmits estimated impression data to the computing device.

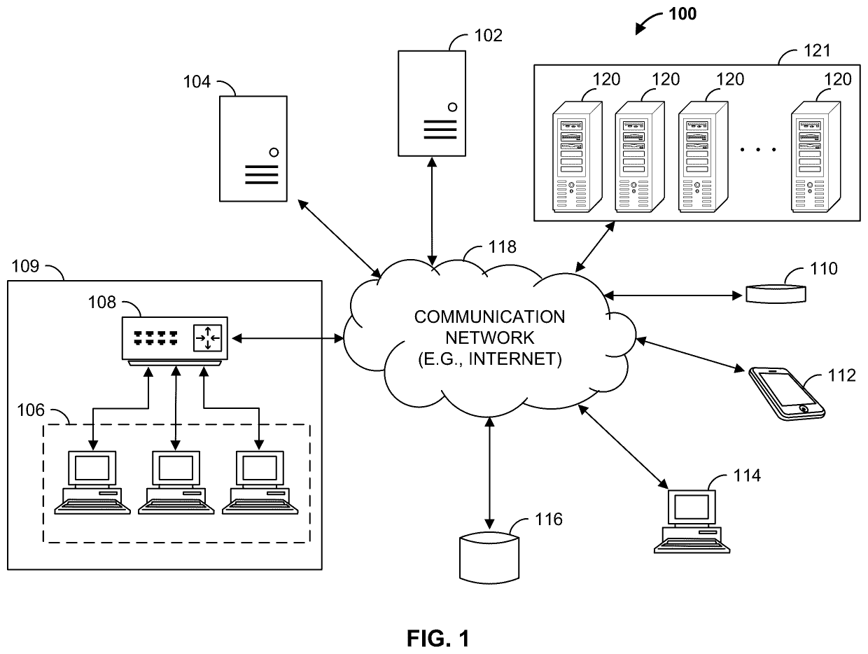

Turning to drawings, FIG. 1 is a network environment 100 configured for estimating advertisement impressions needed for detecting sales lift, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an impression estimation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The impression estimation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the impression estimation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of one or more processing devices 120 are offered as a cloud-based service (e.g., cloud computing). For example, the cloud-based engine 121 may offer computing and storage resources of the one or more processing devices 120 to the impression estimation computing device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the impression estimation computing device 102, the processing devices 120, and/or the web server 104 are operated by a retailer. The multiple user computing devices 110, 112, 114 may be operated by customers and advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the impression estimation computing device 102 over the communication network 118. The workstation(s) 106 may send data to, and receive data from, the impression estimation computing device 102. For example, the workstation(s) 106 may transmit data identifying items purchased by a customer at the store 109 to the impression estimation computing device 102.

Although FIG. 1 illustrates three user computing devices 110, 112, 114, the network environment 100 can include any number of user computing devices 110, 112, 114. Similarly, the network environment 100 can include any number of the impression estimation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the impression estimation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the impression estimation computing device 102.

In some examples, an advertiser or a sponsor of advertisement, e.g., an online seller, may operate one of the user computing devices 110, 112, 114 to initiate a web browser or a user interface that is associated with a website hosted by the web server 104. The advertiser may, via the web browser or the user interface, view item sets sold by the seller on the website, view and manage existing campaigns for some item sets sold by the seller, run an impression estimator to estimate a number of impressions needed to detect a target sales lift for a proposed campaign, and/or create a new campaign for an item set sold by the seller. The website may capture at least some of these activities as campaign data. The web server 104 may transmit the campaign data to the impression estimation computing device 102 over the communication network 118, and/or store the campaign data to the database 116.

In some examples, the web server 104 may transmit an impression estimation request to the impression estimation computing device 102, e.g. upon a selection of an advertiser to run the impression estimator. The impression estimation request may be sent standalone or together with campaign related data of the website. In some examples, the impression estimation request may carry or indicate campaign data of a proposed campaign regarding an item set offered for sale on the website. The campaign data may include information about the item set and a time period proposed as a campaign duration for the campaign.

In some examples, the impression estimation computing device 102 may execute one or more models (e.g., programs or algorithms), such as a machine learning model, deep learning model, statistical model, etc., to compute control sales data in the time period for the item set without the proposed campaign, and compute a number of impressions needed to detect a target sales lift, e.g. 5%, compared to the control sales data in the time period for the item set with the proposed campaign. The impression estimation computing device 102 may generate and transmit estimated impression data based on the number of impressions to the web server 104 over the communication network 118, and the web server 104 may provide the estimated impression data to the advertiser, for the advertiser to determine whether to create the proposed campaign for advertising the item set on the website.

In some examples, the impression estimation computing device 102 may compute the number of impressions needed to detect a target sales lift based on a trained machine learning model and additional data associated with the item set. In some embodiments, the additional data may include one or more of: an impression frequency indicating an average number of impressions each household has, a match rate indicating a percentage of sales that can be matched to a household ID, and a variance adjustment factor indicating an adjustment to an estimated sales variance for the item set with the proposed campaign. In some embodiments, the control sales data may be computed based on at least one model and historical transaction data associated with the item set. In some embodiments, assuming that the number of item sales per household follows a Gaussian distribution, the at least one model may be used to compute mean and variance of the sales number per household in a control group as a function of campaign duration, e.g. based on pre-campaign weekly sales. In some embodiments, the sales numbers for an item set in the present teaching may refer to revenue numbers of the item set.

The impression estimation computing device 102 is further operable to communicate with the database 116 over the communication network 118. For example, the impression estimation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the impression estimation computing device 102, in some examples, the database 116 can be a local storage device, such as a hard drive, a non-volatile memory, or a USB stick. The impression estimation computing device 102 may store online purchase data received from the web server 104 in the database 116. The impression estimation computing device 102 may receive in-store purchase data from different stores 109 and store them in the database 116. The impression estimation computing device 102 may also receive from the web server 104 user session data identifying events associated with browsing sessions, and may store the user session data in the database 116. The impression estimation computing device 102 may also compute estimated impression data in response to an impression estimation request received from the web server 104, and may store the estimated impression data in the database 116.

In some examples, the impression estimation computing device 102 generates and/or updates different models for estimating advertisement impressions needed for detecting sales lift. The models, when executed by the impression estimation computing device 102, allow the impression estimation computing device 102 to compute a number of impressions needed to detect a target sales lift and generate estimated impression data for an advertiser to determine whether and/or how to create an advertising campaign for an item set.

In some examples, the impression estimation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the impression estimation computing device 102 may generate the estimated impression data.

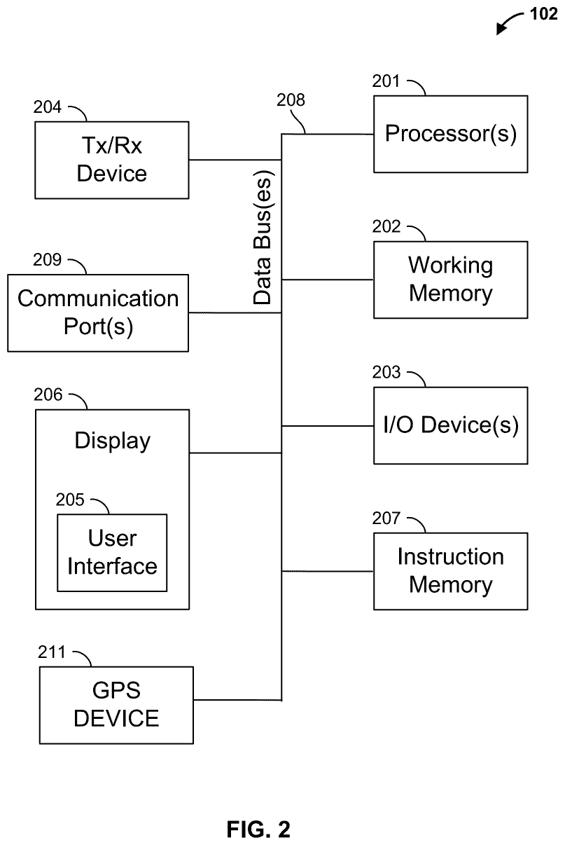

FIG. 2 illustrates a block diagram of an impression estimation computing device, e.g. the impression estimation computing device 102 of FIG. 1, in accordance with some embodiments of the present teaching. In some embodiments, each of the impression estimation computing device 102, the web server 104, the workstation(s) 106, the multiple user computing devices 110, 112, 114, and the one or more processing devices 120 in FIG. 1 may include the features shown in FIG. 2. Although FIG. 2 is described with respect to the impression estimation computing device 102. It should be appreciated, however, that the elements described can be included, as applicable, in any of the impression estimation computing device 102, the web server 104, the workstation(s) 106, the multiple user computing devices 110, 112, 114, and the one or more processing devices 120.

As shown in FIG. 2, the impression estimation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the impression estimation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the impression estimation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the impression estimation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the impression estimation computing device 102 may determine a local geographical area (e.g., town, city, state, etc.) of its position. Based on the geographical area, the impression estimation computing device 102 may determine relevant trend data (e.g., trend data identifying events in the geographical area) and cluster different stores into different regions.

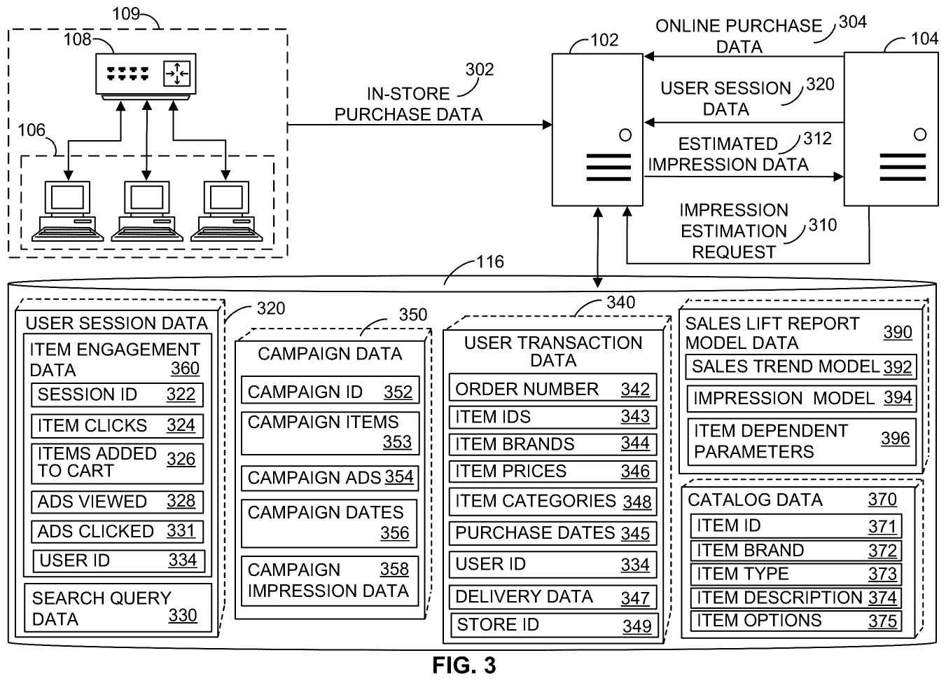

FIG. 3 is a block diagram illustrating various portions of a system for estimating advertisement impressions needed for detecting sales lift, e.g. the system shown in the network environment 100 of FIG. 1, in accordance with some embodiments of the present teaching. As indicated in FIG. 3, the impression estimation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or search query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.). The search query data 330 may identify one or more searches conducted by a user during a browsing session (e.g., a current browsing session).

The impression estimation computing device 102 may also receive online purchase data 304 from the web server 104, which identifies and characterizes one or more online purchases, such as purchases made by the user and other users via a retailer's website hosted by the web server 104. The impression estimation computing device 102 may also receive in-store purchase data 302 from the store 109, which identifies and characterizes one or more in-store purchases. In some embodiments, the in-store purchase data 302 may also indicate other information about the store 109.

The impression estimation computing device 102 may parse the in-store purchase data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, purchase dates 345 identifying the purchase dates of the purchase orders, a user ID 334 for the user making the corresponding purchase, delivery data 347 indicating delivery information for corresponding online orders, and store ID 349 for the corresponding in-store purchase, or for the pickup store or shipping-from store associated with the corresponding online purchase.

In some embodiments, the database 116 may further store campaign data 350, which may identify data of one or more advertising campaigns proposed and/or created for the retailer's website hosted by the web server 104. The campaign data 350 may identify, for each campaign, campaign ID 352 identifying the campaign, campaign items 353 identifying items promoted by the campaign, campaign advertisements 354 identifying advertisements included in the campaign, campaign dates 356 identifying the start and end dates of the campaign, and campaign impression data 358 identifying impression data of the campaign. In some examples, the campaign impression data 358 may identify measured impressions of advertisements in a first campaign, after the first campaign is launched. In some examples, the campaign impression data 358 may identify estimated impressions of advertisements in a second campaign, before the second campaign is launched. In some examples, the campaign impression data 358 may also identify cookies stored by the browsers displaying the advertisements in a campaign.

In some embodiments, the database 116 may further store catalog data 370, which may identify one or more attributes of a plurality of items, such as a portion of or all items a retailer carries. The catalog data 370 may identify, for each of the plurality of items, item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store sales lift report model data 390 identifying and characterizing one or more models and related data for generating a sales lift report. For example, the sales lift report model data 390 may include a sales trend model 392, an impression model 394, and item dependent parameters 396. The sales trend model 392 may be used to compute sales data of items in a control group, e.g. items to be sold during a proposed campaign duration without using the campaign. In some embodiments, the impression estimation computing device 102 may compute, based on the sales trend model 392, an estimated sales data of an item set in a future time period, e.g. next week, based on historical sales data of the item set, e.g. sales data in last several weeks. As such, the sales trend model 392 may capture a sales trend of the item set before the campaign, and estimate a control sales data for the item set during the proposed campaign duration, assuming the item set continues to be sold without the campaign.

The impression model 394 may be used to compute a number of impressions needed to detect a target sales lift compared to the control sales data during the proposed campaign duration for the item set with the advertising campaign. In some embodiments, the impression estimation computing device 102 may compute, based on the impression model 394, estimated mean and variance of sales data of items in a test group, e.g. items to be sold during the proposed campaign duration using the campaign. In some examples, the impression estimation computing device 102 may compute, based on the impression model 394 and the variance of sales data of items, a number of households (e.g. in terms of household IDs) needed to detect the target sales lift compared to the control sales data. The impression estimation computing device 102 can compute the number of impressions needed to detect the target sales lift based on the number of households needed to detect the target sales lift.

In some embodiments, the impression estimation computing device 102 may compute the number of impressions needed to detect the target sales lift based further on one or more of the item dependent parameters 396. In some examples, the item dependent parameters 396 may include an impression frequency indicating an average number of impressions each household has, a match rate indicating a percentage of sales that can be matched to a household ID, and a variance adjustment factor indicating an adjustment to the estimated sales variance for the item set with the proposed campaign. In some embodiments, a household means people living together at a particular address.

In some examples, the impression estimation computing device 102 receives an impression estimation request 310 from the web server 104. The impression estimation request 310 may be associated with a target sales lift for an item set identified by an advertiser, who may be an online seller selling the item set on the retailer's website hosted by the web server 104. For example, the web server 104 may provide a pre-campaign diagnostic tool to the seller, to help the seller to determine how much to pay for an advertising campaign for the item set in a proposed duration, in order to detect the target sales lift for the item set.

In some examples, the impression estimation request 310 is to seek for estimated impressions needed to detect the target sales lift for the item set. Based on the impression estimation request 310, the impression estimation computing device 102 may determine the item set and the proposed campaign duration. The impression estimation computing device 102 may obtain historical transaction data and additional data associated with the item set, from the web server 104 and/or the database 116. Based on the proposed campaign duration, the impression estimation computing device 102 may compute control sales data in the proposed campaign duration for the item set without using the advertising campaign. The impression estimation computing device 102 can also compute, based on a trained model and the additional data, a number of impressions needed to detect the target sales lift with the advertising campaign, compared to the control sales data, in the proposed campaign duration for the item set. The trained model may include one or more of the models in the sales lift report model data 390. In some embodiments, the impression estimation computing device 102 may generate estimated impression data 312 based on the number of impressions needed to detect the target sales lift.

In some embodiments, the impression estimation computing device 102 may assign one or more of the above described operations to a different processing unit or virtual machine hosted by one or more processing devices 120. Further, the impression estimation computing device 102 may transmit the estimated impression data 312 to the web server 104 in response to the impression estimation request 310.

In some embodiments, the estimated impression data 312 includes a sales lift report including computed and estimated data about the proposed campaign. The web server 104 may provide the sales lift report to the seller or advertiser, to help determining whether to create such proposed campaign. In some embodiments, the web server 104 may generate the sales lift report based on the estimated impression data 312 received from the impression estimation computing device 102, and provide the sales lift report to the seller.

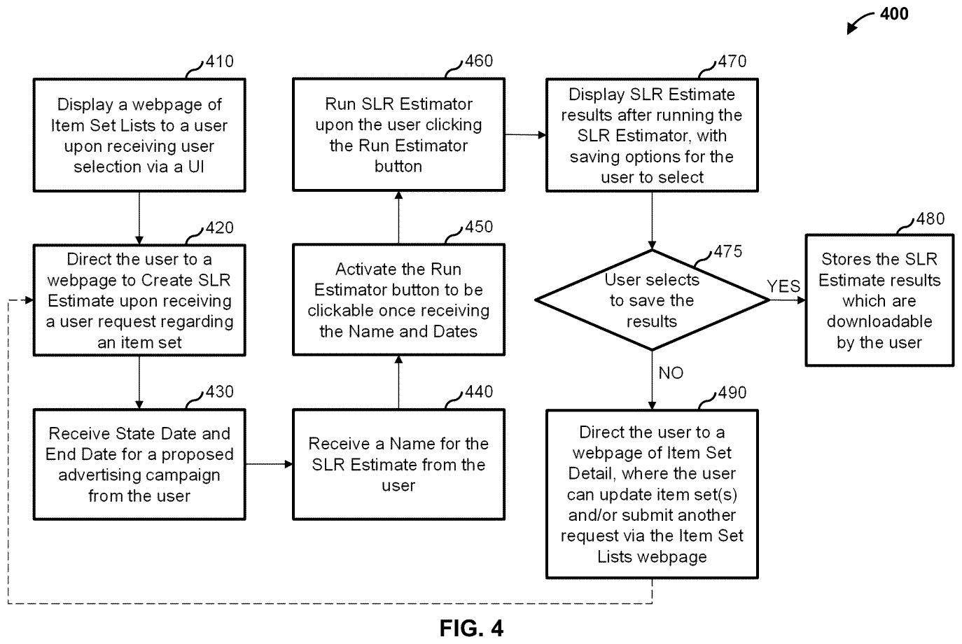

FIG. 4 illustrates a process 400 for providing sales lift report estimates to a user upon request, in accordance with some embodiments of the present teaching. In some embodiments, the process 400 can be carried out by one or more computing devices, such as the web server 104 and/or the impression estimation computing device 102 of FIG. 1. As shown in FIG. 4, the process 400 starts from operation 410, where a webpage is displayed to a user, upon receiving a user selection via a user interface. The webpage and the user interface may be associated with a campaign management tool, which may be used by a user to diagnose a proposed campaign, create a campaign, and/or manage a campaign. The user here may be an online seller, an advertiser, a sponsor of advertisements, or anyone who helps to set up and/or maintain a campaign for advertisers.

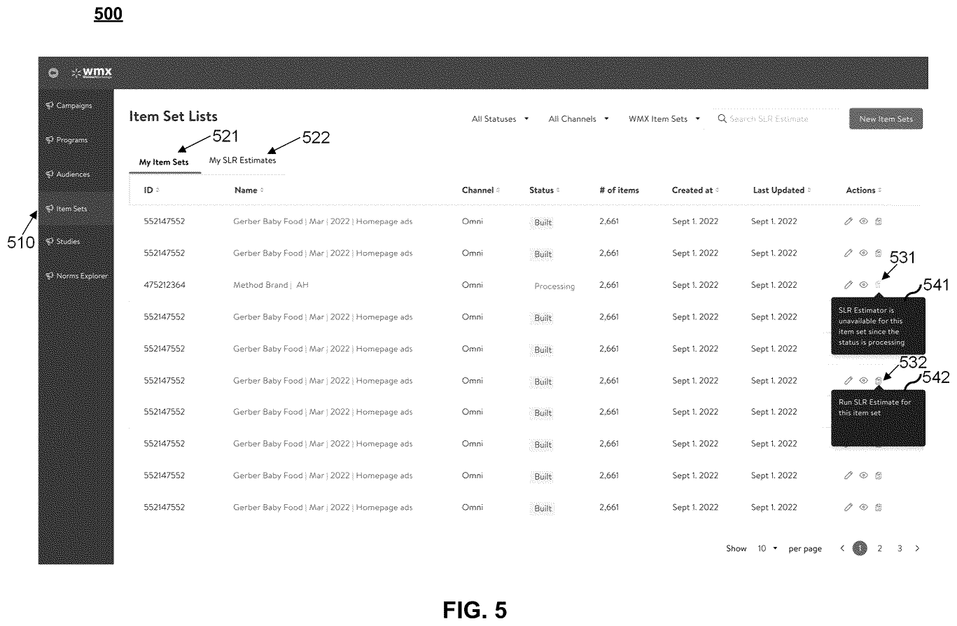

In some embodiments, FIGS. 5-9 illustrate such a user interface displaying webpages provided to a user for providing sales lift report estimates, in accordance with some embodiments of the present teaching. As shown in FIG. 5, a user interface includes a webpage 500 of “Item Set Lists,” which includes two tabs: a first tab 521 for “My Item Sets” and a second tab 522 for “My SLR Estimates.” In the webpage 500, the first tab 521 for “My Item Sets” is activated and shown, after the user selects the “Item Sets” 510 from the left hand navigation bar of the user interface.

As shown in FIG. 5, the first tab 521 for “My Item Sets” shows a list of item sets owned by the user, as well as data related to each of the item sets. For example, for each item set, the first tab 521 for “My Item Sets” shows: an ID for the item set, a name for the item set, a channel for the item set, a status for the item set, a number of items in the item set, a creation date for the item set, a last updated date for the item set, and action options for the item set shown in the “Actions” column. In the example shown in FIG. 5, the action options include: editing the item set, viewing the item set, and running a sales lift report (SLR) estimator for the item set, each represented by a respective icon.

In some embodiments, the SLR estimator can only be run for an item set that is in a “built” status. That is, an item set whose status is “processing” has to wait for the processing to finish, before the SLR estimator can be performed for the item set. For example, as shown in FIG. 5, when the user selects the icon 531 (e.g. by hovering over the icon 531) associated with running SLR estimator, a pop-up message 541 is shown to recite that “SLR Estimator is unavailable for this item set since the status is processing.” In addition, as shown in FIG. 5, when the user selects the icon 532 (e.g. by hovering over the icon 532) associated with running SLR estimator, a pop-up message 542 is shown to recite that “Run SLR Estimator for this item set.”

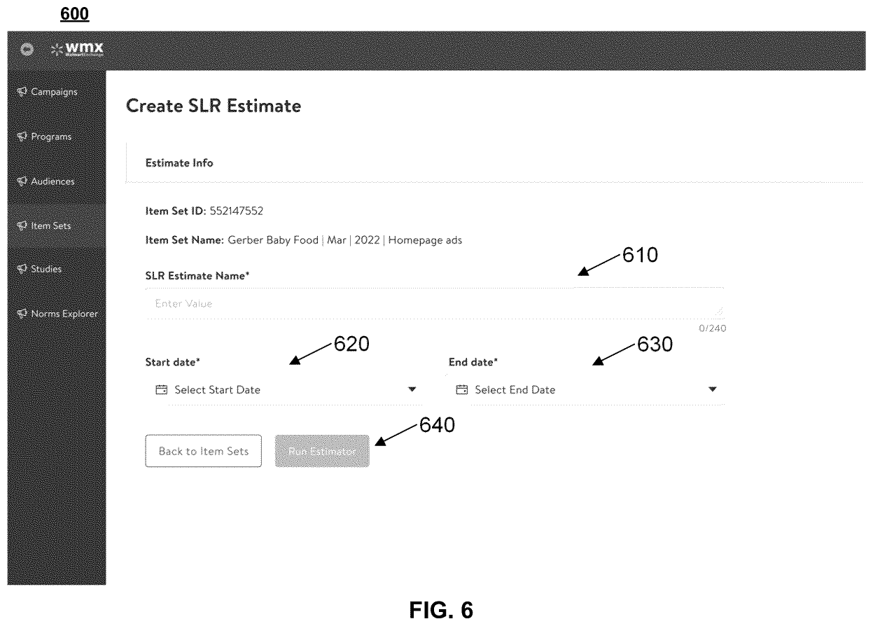

Referring back to FIG. 4, at operation 420, the user is directed to a webpage to create SLR estimate upon receiving a user request regarding an item set. In the example shown in FIG. 5, once an item set has a “built” status in the “Status column,” an icon in the “Actions” column will appear to be clickable. After the user selects (e.g. by clicking the icon 532) a corresponding item set to run the SLR estimator, the user is directed to a “Create SLR Estimate” webpage 600 as shown in FIG. 6.

In some examples, an SLR estimator helps to determine the minimum number of impressions that will be required to detect non-zero lifts in a statistically significant way. Campaigns that run at the recommended impressions will detect lifts higher than a fixed threshold approximately 80% of the time. While the confidence level is chosen to be 80% in this example, the confidence level may be another number, e.g. 85%, 90% or 95%, in other examples. The threshold for the sales lift may be 5%, 10%, or another percentage predetermined based on system configuration and/or user inputs. If a user wants to detect a lower actual sales lift than the threshold, more impressions than the recommended impressions will be needed. If a user wants to detect a higher actual sales lift than the threshold, less impressions than the recommended impressions will be needed.

As shown in FIG. 6, the webpage 600 includes information about an item set for which an SLR estimate is to be created, e.g. an item set ID and an item set name. In some embodiments, the webpage 600 may also include a description about SLR. In addition, the webpage 600 also includes: a textbox 610 for the user to enter a name for the SLR Estimate, a textbox or drop-down calendar 620 for the user to enter or select a start date for a proposed campaign for SLR estimate, and a textbox or drop-down calendar 630 for the user to enter or select an end date for the proposed campaign. The webpage 600 also includes a “Run Estimator” button 640 for running the SLR estimator. As shown in FIG. 6, the “Run Estimator” button 640 is inactive because no data has been input at the textbox 610 and the drop-down calendars 620, 630.

Referring back to FIG. 4, a start date and an end date for a proposed advertising campaign are received from the user at operation 430. A name for the SLR estimate based on the proposed advertising campaign is received from the user at operation 440. Then at operation 450, the Run Estimator button is activated to be clickable once receiving the name and the dates.

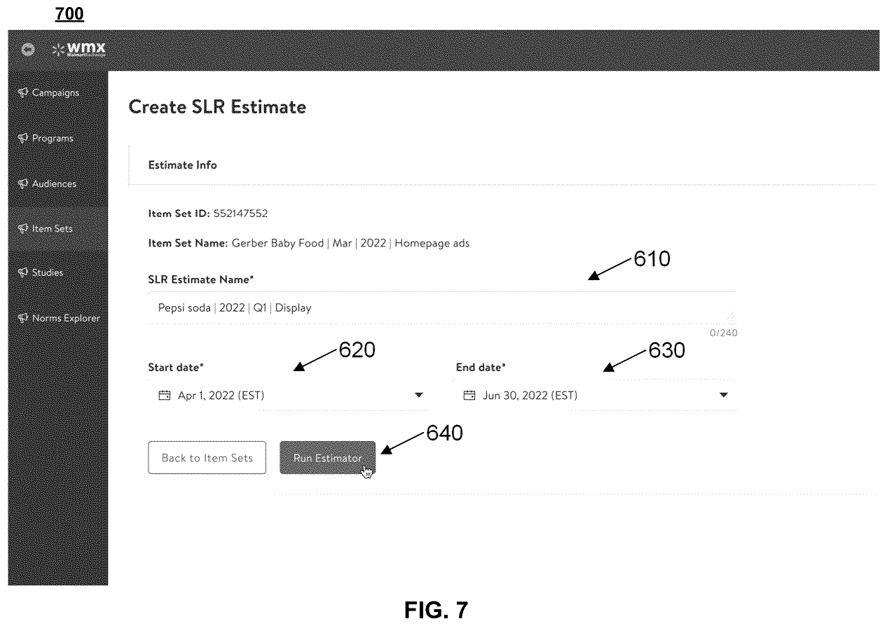

FIG. 7 shows a webpage 700, which is a filled-up version of the “Create SLR Estimate” webpage 600. The webpage 700 is the same as the webpage 600, except that data has been input at the textbox 610 and the drop-down calendars 620, 630 in the webpage 700, such that the “Run Estimator” button 640 is now active and clickable. As shown in FIG. 7, the user may now click the “Run Estimator” button 640 to run the SLR estimator. In some embodiments, the user may specify a portion of the item set to be measured for SLR estimate.

Referring back to FIG. 4, the SLR estimator is run at operation 460, upon the user clicking the Run Estimator button. At operation 470, SLR estimate results are displayed after running the SLR estimator, with saving options for the user to select. In some embodiments, the SLR estimate results can be generated and displayed within one minute, or even 10 seconds, from the user clicking the Run Estimator button.

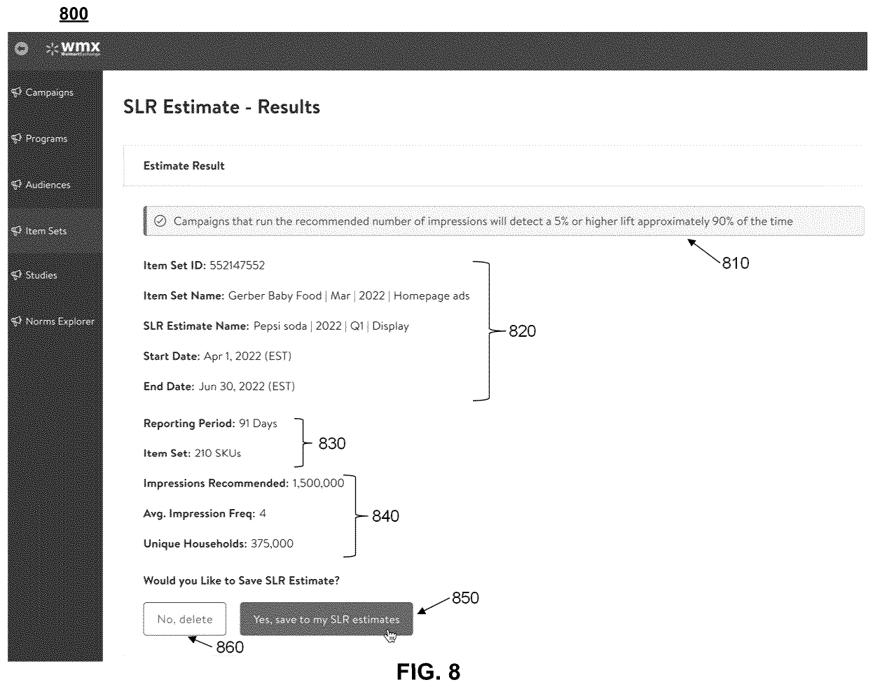

FIG. 8 shows a webpage 800 providing results of the SLR estimate, which may be performed by the SLR estimator upon the user clicking the “Run Estimator” button 640 shown in FIG. 7. As shown in FIG. 8, the SLR estimate results may include: an estimate result message 810, a list of basic information 820, a list of derived information 830, and a list of computed information 840. The estimate result message 810 in this example indicates that “Campaigns that run the recommended number of impressions will detect a 5% or higher lift approximately 90% of the time.” The basic information 820 in this example includes data known before running the SLR estimator, e.g. the pre-identified item set ID, the pre-identified item set name, the SLR estimate name input by the user, the start date input by the user, and the end date input by the user. The derived information 830 in this example includes data derived from the basic information 820, e.g. the reporting period which is equal to a proposed campaign duration determined based on the start and end dates input by the user, and the number of SKUs within the pre-identified item set. The computed information 840 in this example includes data computed when running the SLR estimator, including a number of impressions recommended, an average impression frequency, and a number of unique households.

As shown in FIG. 8, the number of impressions recommended is 1.5 million, which means that a campaign needs to run at least 1.5 million impressions to achieve statistical power to detect sales lift, which in this example is to detect a 5% or higher sales lift with 90% confidence. This number of impressions can be computed based on one or more models in the sales lift report model data 390. In some embodiments, this number of impressions is recommended to the user if the user wants to know whether the sales lift is 5% compared to a control group without campaign.

The average impression frequency in this example is 4, which means on average each household has 4 impressions during the campaign duration or reporting period of 91 days. The number of unique households in this example is 375,000, which means data from at least 375,000 household IDs are needed to detect a 5% or higher sales lift with 90% confidence. In this example, the number of impressions recommended is equal to a multiplication product of the average impression frequency and the number of unique households. Given the average impression frequency determined based on historical data, the number of impressions recommended and the number of unique households can be derived from one another.

As shown in FIG. 8, the webpage 800 also asks whether the user would like to save the SLR estimate results. Accordingly, the user may either click a button 850 to save the SLR estimate results into a list of “my SLR estimates” associated with the user, or click a button 860 to delete the SLR estimate results.

Referring back to FIG. 4, at operation 475, it is determined whether the user selects to save the SLR estimate results. If so, the process 400 goes to operation 480, where the SLR estimate results are stored to be downloadable by the user. If not, the process 400 goes to operation 490, where the user is directed to a webpage of Item Set Detail, such that the user can update item set(s) and/or submit another request via the Item Set Lists webpage. If an additional request is submitted, the process 400 may go back to operation 420 to proceed with the additional request.

In some examples, the user may enlarge an item set by adding some related items into the item set, e.g. after realizing that the related items can be impacted by a same campaign as the existing items in the item set. Then, the user may run the SLR estimator again for the enlarged item set. After trying different item sets and/or different combinations of items in an item set, the user can determine what campaign to create for which item set.

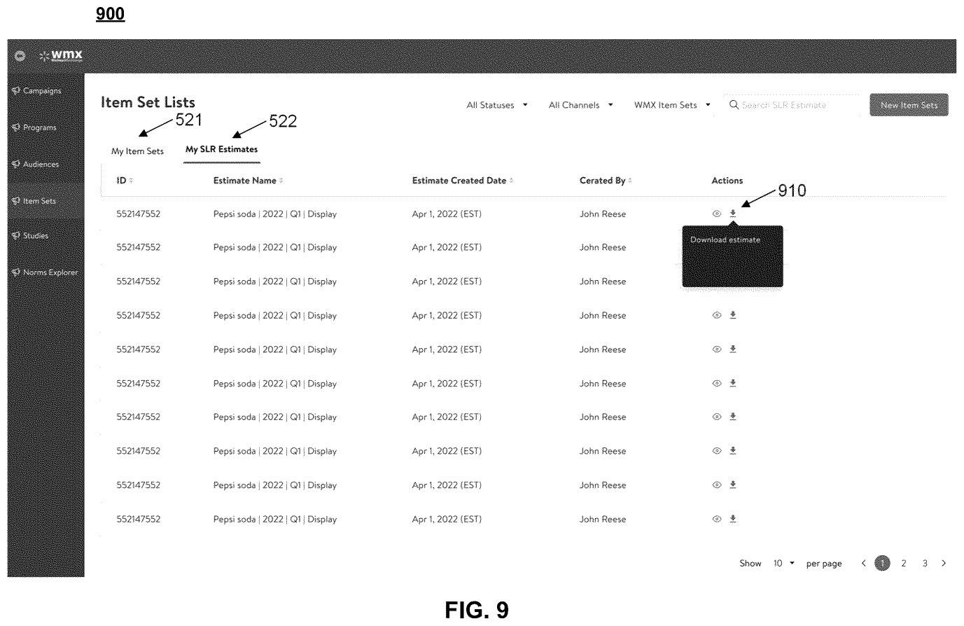

FIG. 9 shows a webpage 900 including two tabs: the first tab 521 for “My Item Sets” and the second tab 522 for “My SLR Estimates,” same as the webpage 500 in FIG. 5. But different from the webpage 500, the second tab 522 for “My SLR Estimates,” rather than the first tab 521 for “My Item Sets,” is activated and shown in the webpage 900, e.g. after the user clicking the button 850 to save the SLR estimate results. As shown in FIG. 9, for each saved SLR estimate under the second tab 522, there is a clickable icon 910 for the user to download the saved estimate. In some embodiments, one or more of the SLR estimate results may be stored in the campaign data 350 in the database 116.

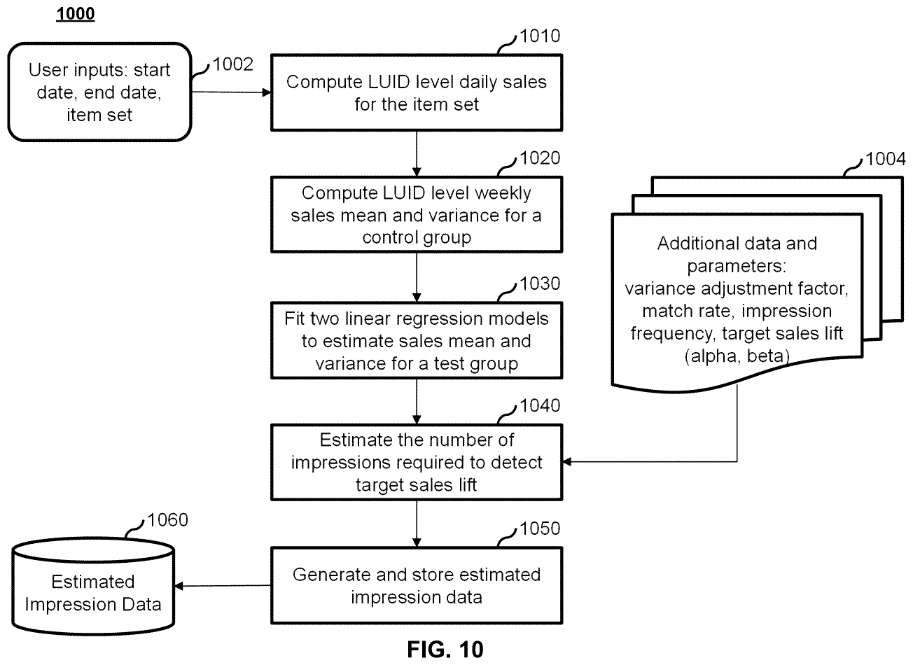

FIG. 10 illustrates an exemplary method 1000 for computing estimated impression data to detect a target sales lift for an item set, in accordance with some embodiments of the present teaching. In some embodiments, the method 1000 can be carried out by one or more computing devices, such as the impression estimation computing device 102 and/or the cloud-based engine 121 of FIG. 1. In some embodiments, the method 1000 can be carried out by the impression estimation computing device 102 and/or the cloud-based engine 121 to run the SLR estimator at the operation 460 in FIG. 4. For example, when performing the operation 460 in FIG. 4, the web server 104 may send an impression estimation request 310 to the impression estimation computing device 102. Based on the impression estimation request 310, the impression estimation computing device 102 may perform the method 1000 to generate and transmit the estimated impression data 312 to the web server 104, in response to the impression estimation request 310.

As shown in FIG. 10, the method 1000 starts from operation 1010, where a living unit ID (LUID) level daily sales are computed for the item set. A LUID may be a household ID identifying a unique household. In some embodiments, the LUID can be determined from a user ID, e.g. a cookie ID. For example, one or more cookie IDs may be matched to one LUID. The LUID level daily sales represent daily sales number of an item set per each LUID, i.e. per each household.

In some embodiments, the LUID level daily sales may be computed based on user input data 1002, including e.g. a start date and an end date of a proposed campaign, and the item set selected by the user. In some embodiments, the user input data 1002 may be received together with the impression estimation request 310 from the web server 104, which can obtain the user input data 1002 via a user interface as shown in FIGS. 5-7. In some embodiments, the user input data 1002 may be retrieved from the database 116, where the web server 104 can store the user input data 1002, e.g. as part of the campaign data 350.

Then at operation 1020, LUID level weekly sales mean and variance are computed for a control group, e.g. by aggregating the LUID level daily sales computed at operation 1010. In some embodiments, the average LUID level item sales is assumed to follow a Gaussian or normal distribution. In some embodiments, the mean and variance of LUID level sales for a control group can be treated as a function of campaign duration, and can thus be estimated from pre-campaign weekly sales. The control group may refer to a scenario when the item set continues to be sold without the campaign during the proposed campaign duration.

To predict how the campaign will perform in a future time period, a similar time period in terms of the length from a past history can be used to model the sales with the campaign in the future time period. In some examples, a campaign will last for 8 weeks (i.e. 56 days). The impression estimation computing device 102 can compute the LUID level sales mean and variance based on 7 days, 14 days, 21 days, 28 days, etc. before the campaign and build a model, e.g. the sales trend model 392 in the database 116, to capture the sales trend. The sales trend may be used to compute the LUID level sales mean and variance for the campaign duration of 8 weeks, e.g. based on interpolation or extrapolation. In some embodiments, the mean and variance of LUID level sales are computed in consideration of seasonality and item set selections.

In some examples, for an item set having not enough historical sales data, the mean and variance of LUID level sales for the control group can be estimated from pre-campaign weekly sales of a similar item set.

At operation 1030, two linear regression models are fit to estimate sales mean and variance, respectively, for a test group. The test group may refer to a scenario when the item set is sold as being advertised with the campaign during the proposed campaign duration. At operation 1040, the number of impressions required to detect target sales lift is estimated based on: the estimated sales variance for the test group and additional data and parameters 1004. In this example, the additional data and parameters 1004 include: variance adjustment factor, match rate, impression frequency, target sales lift (alpha, beta). These additional data and parameters 1004 can be obtained either from user inputs or based on a previous machine learning training process, and can help to accommodate different situations, e.g. different campaigns for different item sets by different advertisers.

In some embodiments, a sales lift ρ is defined as a percentage below in equation (1):

$$ρ = \frac{{μ}_{test} - {μ}_{ctr}}{{μ}_{ctr}} \qquad ( 1 )$$

where μₜₑₛₜ represents a mean of LUID level sales number for the item set in a test group; μ_{ctr} represents a mean of LUID level sales number for the item set in a control group. In some embodiments, since it is difficult to directly estimate the distribution of ρ as a ratio of two random variables, the impression estimation computing device 102 can treat μ_{ctr} as constant and estimate μ_{ctr} first, e.g. based on the sales trend model 392 in the database 116, as discussed above.

In some embodiments, a power analysis is used to compute the number of households (e.g. LUIDs) needed in order to detect a target sales lift, which may be determined as the percentage sales lift ρ, or a sales number lift Δ=ρ×μ_{ctr}. In some embodiments, given α (a type I error rate) and β (a type II error rate) associated with the target sales lift, the number n of needed households can be computed as below in equation (2):

$$n \frac{{( {Z}_{1 - \frac{α}{2}} + {Z}_{1 - β} )}^{2} {σ}_{test}^{2}}{{Δ}^{2}} , \qquad ( 2 )$$

where Z represents a percentile of a standard normal distribution; σₜₑₛₜ² represents a variance of LUID level sales for the item set in the test group. In some embodiments, Z can be determined based on a reference table for a standard normal distribution.

In some embodiments, σₜₑₛₜ² can be computed similarly as the variance of LUID level sales for the item set in the control, following a sales trend captured from historical data, assuming the sales variance will be similar between the test and control groups. In some embodiments, α and β are parameters for statistical power analysis. In some examples, α equals point 0.05 and β equals 0.8.

In some embodiments, the number of needed households can be converted to the number of needed impressions (ImpressionNeeded), following equation (3):

$$ImpressionNeeded = \frac{{( {Z}_{1 - \frac{α}{2}} + {Z}_{1 - β} )}^{2} * {( {σ}_{control} * VarianceAdjFactor )}^{2} * ImpressionFrequency}{{( TargetedLift * {μ}_{control} )}^{2} * MatchRate} \qquad ( 3 )$$

where VarianceAdjFactor is a variance adjustment factor used to adjust the sales variance of test LUIDs; ImpressionFrequency is an average impression frequency representing an average number of impressions each LUID has; TargetedLift is a target lift percentage ρ (e.g. 5% or 10%); μ_{control} is the same as μ_{ctr}; MatchRate is a match rate representing a percentage of cookies that can be mapped back to LUIDs.

In some embodiments, the various adjustment factor can be different under different item categories. Similarly, the match rates may also be different under different item categories. In some embodiments, a match rate may be determined by mapping each browser ID or cookie ID to a household. A lower match rate means many online buyers are unknown and cannot be matched to a household ID. Accordingly, maybe more impressions are needed to compensate the lower match rate (to reach the unknown buyers) for detecting the same target sales lift.

In some embodiments, the average impression frequency may also be different under different item categories. In various embodiments, the average impression frequency may be determined based on user inputs and/or historical data.

In various embodiments, for each model discussed above for prediction of mean or variance, there is an associated confidence interval for the predicted value based on the model, to identify a lower bound and an upper bound for the predicted value with certain probability.

Referring back to the method 1000 in FIG. 10, at operation 1050, estimated impression data is generated, e.g. based on the number of impressions required to detect target sales lift, and stored into a database 1060, which may be a standalone database or part of the database 116.

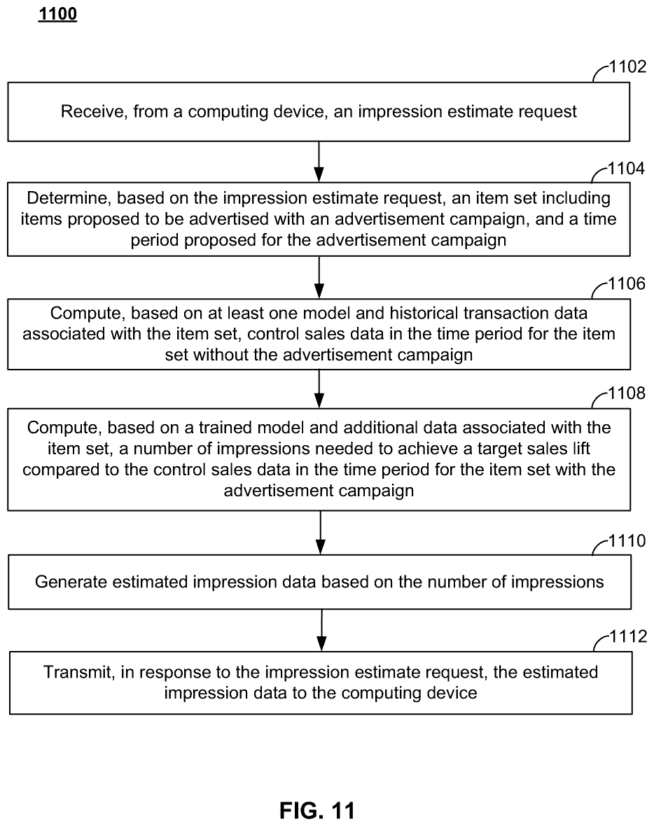

FIG. 11 is a flowchart illustrating an exemplary method 1100 for estimating advertisement impressions needed for detecting sales lift, in accordance with some embodiments of the present teaching. In some embodiments, the method 1100 can be carried out by one or more computing devices, such as the impression estimation computing device 102 and/or the cloud-based engine 121 of FIG. 1. Beginning at operation 1102, an impression estimate request is received from a computing device. At operation 1104, an item set and a time period are determined based on the impression estimate request. The item set includes items proposed to be advertised with an advertisement campaign. The time period is a campaign duration proposed for the advertisement campaign. At operation 1106, control sales data in the time period is computed for the item set without the advertisement campaign, based on at least one model and historical transaction data associated with the item set. A number of impressions is computed at operation 1108 based on a trained model and additional data associated with the item set. The number of impressions represents impressions needed to detect a target sales lift compared to the control sales data in the time period for the item set with the advertisement campaign. At operation 1110, estimated impression data is generated based on the number of impressions. At operation 1112, the estimated impression data is transmitted to the computing device in response to the impression estimate request.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, an impression estimation request,
determine, based on the impression estimation request, an item set including at least one item proposed to be advertised with an advertising campaign,
determine a target sales lift for the item set with the advertising campaign,
generate estimated impression data based on the target sales lift, and
transmit the estimated impression data to the computing device.

2. The system of claim 1, wherein:
the impression estimation request is generated based on input data from a user via a user interface; and
the input data comprises information related to at least one of: the item set, a start time of the advertising campaign, an end time of the advertising campaign, a name associated with the impression estimation request.

3. The system of claim 1, wherein the at least one processor is configured to:
determine, based on the impression estimation request, a time period proposed for the advertising campaign;
compute control sales data for the item set in the time period in accordance with a scenario that the item set is sold without the advertising campaign in the time period; and
compute test sales data for the item set in the time period in accordance with a scenario that the item set is sold with the advertising campaign in the time period.

4. The system of claim 3, wherein the at least one processor is configured to:
compute daily sales data for the item set based on historical transaction data associated with the item set, wherein the daily sales data includes a daily sales number of the item set per each household; and
compute weekly sales data for the item set based on the daily sales data, wherein the control sales data and the test sales data are computed based on the weekly sales data.

5. The system of claim 3, wherein the estimated impression data is generated based on:
obtaining metadata associated with the impression estimation request;
computing, using a machine learning model and the metadata, a number of impressions needed to detect the target sales lift from the control sales data to the test sales data for the item set in the time period; and
generating the estimated impression data based on the number of impressions.

6. The system of claim 5, wherein computing the number of impressions comprises:
computing a control mean and a control variance of a probability distribution of the control sales data;
computing a test mean and a test variance of a probability distribution of the test sales data; and
computing the number of impressions using the machine learning model based on: the control mean, the test mean, the test variance, and the metadata.

7. The system of claim 6, wherein:
the control mean and the control variance are computed based on a sales trend model;
the test mean and the test variance are computed based on two linear regression models;
the metadata comprises: a variance adjustment factor, a match rate, an impression frequency, the target sales lift, and a confidence level associated with the target sales lift; and
the machine learning model is trained based on historical transaction data to optimize the confidence level.

8. The system of claim 5, wherein:
the estimated impression data comprises: the time period proposed for the advertising campaign, a size of the item set, the number of impressions needed to detect the target sales lift, the confidence level, an average impression frequency, and a number of unique households; and
the estimated impression data is displayed to the user via a user interface.

9. A computer-implemented method, comprising:
receiving, from a computing device, an impression estimation request;
determining, based on the impression estimation request, an item set including at least one item proposed to be advertised with an advertising campaign;
determining a target sales lift for the item set with the advertising campaign;
generating estimated impression data based on the target sales lift; and
transmit the estimated impression data to the computing device.

10. The computer-implemented method of claim 9, wherein:
the impression estimation request is generated based on input data from a user via a user interface; and
the input data comprises information related to at least one of: the item set, a start time of the advertising campaign, an end time of the advertising campaign, or a name associated with the impression estimation request.

11. The computer-implemented method of claim 9, further comprising:
determining, based on the impression estimation request, a time period proposed for the advertising campaign;
computing control sales data for the item set in the time period in accordance with a scenario that the item set is not advertised with the advertising campaign in the time period; and
computing test sales data for the item set in the time period in accordance with a scenario that the item set is advertised with the advertising campaign in the time period.

12. The computer-implemented method of claim 11, further comprising:
computing daily sales data for the item set based on historical transaction data associated with the item set, wherein the daily sales data includes a daily sales number of the item set per each household; and
computing weekly sales data for the item set based on the daily sales data, wherein the control sales data and the test sales data are computed based on the weekly sales data.

13. The computer-implemented method of claim 11, wherein generating the estimated impression data comprises:
obtaining metadata associated with the impression estimation request;
computing, using a machine learning model and the metadata, a number of impressions needed to detect the target sales lift from the control sales data to the test sales data for the item set in the time period; and
generating the estimated impression data based on the number of impressions.

14. The computer-implemented method of claim 13, wherein computing the number of impressions comprises:
computing a control mean and a control variance of a probability distribution of the control sales data;
computing a test mean and a test variance of a probability distribution of the test sales data; and
computing the number of impressions using the machine learning model based on: the control mean, the test mean, the test variance, and the metadata.

15. The computer-implemented method of claim 14, wherein:
the control mean and the control variance are computed based on a sales trend model;
the test mean and the test variance are computed based on two linear regression models;
the metadata comprises: a variance adjustment factor, a match rate, an impression frequency, the target sales lift, and a confidence level associated with the target sales lift; and
the machine learning model is trained based on historical transaction data to optimize the confidence level.

16. The computer-implemented method of claim 13, wherein:
the estimated impression data comprises: the time period proposed for the advertising campaign, a size of the item set, the number of impressions needed to detect the target sales lift, the confidence level, an average impression frequency, and a number of unique households; and
the estimated impression data is displayed to the user via a user interface.

17. A non-transitory computer readable medium having instructions stored thereon, wherein the instructions, when executed by at least one processor, cause at least one device to perform operations comprising:
receiving, from a computing device, an impression estimation request;
determining, based on the impression estimation request, an item set including at least one item proposed to be advertised with an advertising campaign;
determining a target sales lift for the item set with the advertising campaign;
generating estimated impression data based on the target sales lift; and
transmit the estimated impression data to the computing device.

18. The non-transitory computer readable medium of claim 17, wherein the instructions, when executed by at least one processor, cause the at least one device to perform further operations comprising:
determining, based on the impression estimation request, a time period proposed for the advertising campaign;
computing control sales data for the item set in the time period in accordance with a scenario that the item set is not advertised with the advertising campaign in the time period; and
computing test sales data for the item set in the time period in accordance with a scenario that the item set is advertised with the advertising campaign in the time period.

19. The non-transitory computer readable medium of claim 18, wherein generating the estimated impression data comprises:
obtaining metadata associated with the impression estimation request;
computing, using a machine learning model and the metadata, a number of impressions needed to detect the target sales lift from the control sales data to the test sales data for the item set in the time period; and
generating the estimated impression data based on the number of impressions.

20. The non-transitory computer readable medium of claim 19, wherein computing the number of impressions comprises:
computing a control mean and a control variance of a probability distribution of the control sales data;
computing a test mean and a test variance of a probability distribution of the test sales data; and
computing the number of impressions using the machine learning model based on: the control mean, the test mean, the test variance, and the metadata.
